(19) United States
(12) Patent Application Publication
(10) Pub. No.: US 2025/0306822 A1
(43) Pub. Date: Oct. 2, 2025

(54) COMMUNICATION SYSTEM AND PRINTING APPARATUS

(71) Applicant: SEIKO EPSON CORPORATION, TOKYO (JP)

(72) Inventors: Aldo Laksana Putra SUPARMAN, BEKASI (ID); Riky YONATHAN, BEKASI (ID)

(21) Appl. No.: 19/091,948

(22) Filed: Mar. 27, 2025

(30) Foreign Application Priority Data
Mar. 27, 2024 (JP) 2024-051318

(51) Int. Cl. G06F 3/12

(52) U.S. Cl. CPC G06F 3/1236; G06F 3/1204

(57) ABSTRACT

A communication system includes a first multifunction peripheral, a second multifunction peripheral, and an access point to which the first multifunction peripheral makes a communication connection. The first multifunction peripheral outputs connection information including first connection information for the second multifunction peripheral to make a communication connection to the access point and second connection information for the second multifunction peripheral to make a communication connection to the first multifunction peripheral via the access point, and the second multifunction peripheral receives input of the connection information and makes a communication connection to the access point based on the first connection information contained in the connection information and makes a communication connection to the first multifunction peripheral via the access point based on the second connection information contained in the connection information.

The present application is based on, and claims priority from JP Application Serial Number 2024-051318, filed Mar. 27, 2024, the disclosure of which is hereby incorporated by reference herein in its entirety.

### BACKGROUND

### 1. Technical Field

The present disclosure relates to a communication system and a printing apparatus.

### 2. Related Art

JP-A-2018-1526 discloses that a first printing apparatus prints a special code containing setting information, and the setting information is set in a second printing apparatus based on a result of scanning of the special code by the second printing apparatus.

JP-A-2018-1526 is an example of the related art.

However, in the technique described in JP-A-2018-1526, communication made between the first printing apparatus and the second printing apparatus is not disclosed, and there is room for improvement in view of an increase in user's convenience.

### SUMMARY

A communication system according to an aspect of the present disclosure includes a first information processing apparatus, a second information processing apparatus, and an access point to which the first information processing apparatus makes a communication connection, wherein the first information processing apparatus outputs connection information including first connection information for the second information processing apparatus to make a communication connection to the access point and second connection information for the second information processing apparatus to make a communication connection to the first information processing apparatus via the access point, and the second information processing apparatus receives input of the connection information, makes a communication connection to the access point based on the first connection information contained in the connection information, and makes a communication connection to the first information processing apparatus via the access point based on the second connection information contained in the connection information.

A printing apparatus according to another aspect of the present disclosure is a printing apparatus making a communication connection to an access point, the printing apparatus outputs connection information including first connection information for another printing apparatus to make a communication connection to the access point and second connection information for the other printing apparatus to make a communication connection to the printing apparatus via the access point, the printing apparatus transmits setting information of the printing apparatus to the other printing apparatus when the other printing apparatus makes a communication connection to the printing apparatus via the access point based on the connection information, wherein the setting information includes at least one of print setting information, scan setting information, copy setting information, facsimile setting information including a telephone directory, network information, setting network security setting information, and administrator information.

### BRIEF DESCRIPTION OF THE DRAWINGS

FIG. 1 shows an example of a configuration of a communication system according an embodiment.

FIG. 2 shows an example of a configuration of a first multifunction peripheral according to the embodiment.

FIG. 3 is a table showing an example of setting information.

FIG. 4 shows an example of a configuration of a second multifunction peripheral according to the embodiment.

FIG. 5 shows an example of main processing of the communication system.

FIG. 6 is a sequence diagram showing an example of the main processing of the communication system.

### DESCRIPTION OF EMBODIMENTS

As below, an embodiment will be described with reference to the drawings.

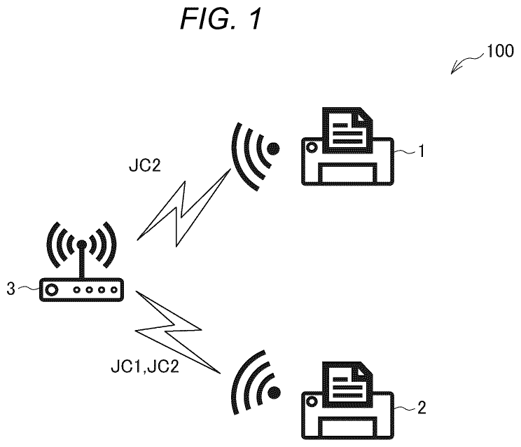

First, a configuration of a communication system 100 according to the embodiment will be described with reference to FIG. 1. FIG. 1 shows an example of the configuration of the communication system 100 according to the embodiment. As shown in FIG. 1, the communication system 100 includes a first multifunction peripheral 1, a second multifunction peripheral 2, and an access point 3. Each of the first multifunction peripheral 1 and the second multifunction peripheral 2 is a so-called MFP (Multi-Function Peripheral).

The first multifunction peripheral 1 is communicably connected to an access point 3. The first multifunction peripheral 1 is communicably connected to the second multifunction peripheral 2 via the access point 3.

The first multifunction peripheral 1 and the access point 3 communicate with each other according to, for example, the Wi-Fi (registered trademark) standard. The second multifunction peripheral 2 and the access point 3 communicate with each other according to, for example, the Wi-Fi (registered trademark) standard.

The first multifunction peripheral 1 corresponds to an example of “first information processing apparatus”.

Further, the first multifunction peripheral 1 corresponds to an example of “printing apparatus”.

The access point 3 is, for example, a router.

In the embodiment, a case where the access point 3 is a router is described, however, not limited to that. The access point 3 may be, for example, a hub (HUB).

The first multifunction peripheral 1 outputs connection information JC. The connection information JC includes first connection information JC1 and second connection information JC2. The first connection information JC1 is connection information for the second multifunction peripheral 2 to make a communication connection to the access point 3. The second connection information JC2 is connection information for the second multifunction peripheral 2 to make a communication connection to the first multifunction peripheral 1 via the access point 3.

The second multifunction peripheral 2 has substantially the same configuration as the first multifunction peripheral 1. The second multifunction peripheral 2 is, for example, the same model manufactured by the same manufacturer as the first multifunction peripheral 1.

The second multifunction peripheral 2 receives the connection information JC. The connection information JC contains the first connection information JC1 and the second connection information JC2. The second multifunction peripheral 2 makes a communication connection to the access point 3 based on the first connection information JC1. The second multifunction peripheral 2 makes a communication connection to the first multifunction peripheral 1 via the access point 3 based on the second connection information JC2.

The second multifunction peripheral 2 corresponds to an example of “second information processing apparatus”.

The second multifunction peripheral 2 corresponds to an example of “another printing apparatus”.

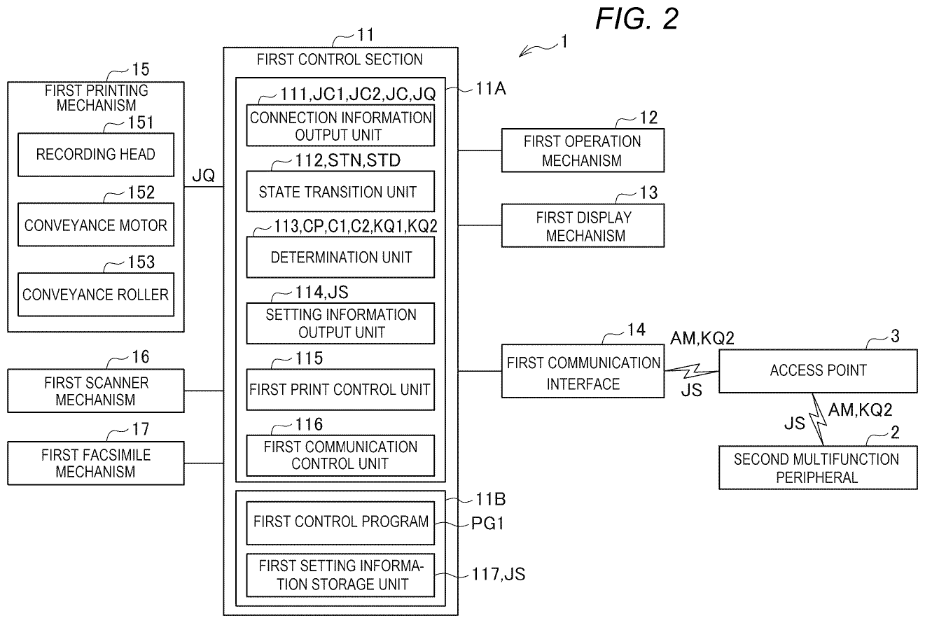

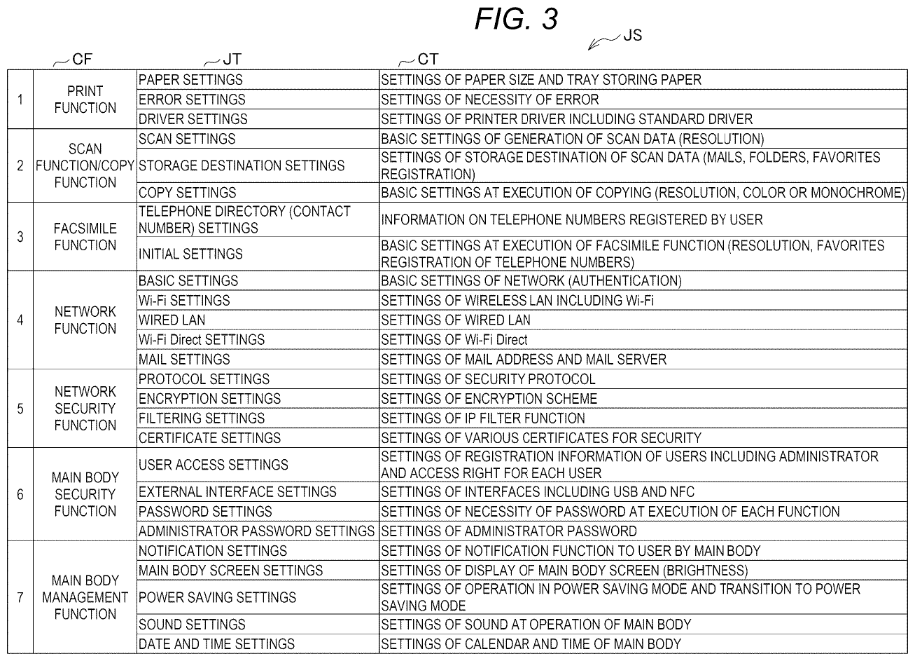

The connection information JC, the first connection information JC1, and the second connection information JC2 will be further described with reference to FIGS. 2 and 3.

Next, a configuration of the first multifunction peripheral 1 will be described with reference to FIG. 2. FIG. 2 shows an example of the configuration of the first multifunction peripheral 1 according to the embodiment.

As shown in FIG. 2, the first multifunction peripheral 1 includes a first control section 11, a first operation mechanism 12, a first display mechanism 13, a first communication interface 14, a first printing mechanism 15, a first scanner mechanism 16, and a first facsimile mechanism 17.

The first control section 11 controls operation of the respective units of the first multifunction peripheral 1. Each of the first operation mechanism 12, the first display mechanism 13, the first communication interface 14, the first printing mechanism the first scanner mechanism 16, and the first facsimile mechanism 17 is configured to communicate with the first control section 11.

The first control section 11 has a first processor 11A such as a CPU (Central Processing Unit), and a first memory 11B such as a ROM (Read Only Memory). The memory 11B stores a first control program PG1.

The first processor 11A may include a plurality of processors or a single processor.

The first processor 11A may be hardware programmed to implement functions of the respective units, which will be described later. That is, the first processor 11A may have a configuration in which the first control program PG1 is mounted as a hardware circuit. In this case, for example, the first processor 11A includes an ASIC (Application Specific Integrated Circuit), an FPGA (Field-Programmable Gate Array), or the like.

In the following description, the first processor 11A executes the first control program PG1 to implement various functions of the first control section 11.

The first memory 11B includes a nonvolatile storage area for storing programs and data in a nonvolatile manner. The first memory 11B may include, for example, a ROM, an HDD (Hard Disk Drive), or an SSD (Solid State Drive) as a nonvolatile storage area. The first memory 11B may include a volatile storage area and form a work area for temporarily storing programs to be executed by the first processor 11A and data to be processed. The first memory 11B may include, for example, a RAM (Random Access Memory) as a volatile storage area.

The first operation mechanism 12 includes an input unit such as an operation switch and a touch panel provided in the first multifunction peripheral 1, detects an operation on the input unit by a user, and outputs a detection signal corresponding to the operation to the first control section 11. The first control section 11 executes processing corresponding to the operation by the user based on input from the first operation mechanism 12. The user is, for example, an administrator of the first multifunction peripheral 1.

The first display mechanism 13 includes a plurality of LEDs (Light Emitting Diodes) and a display panel such as an LCD (Liquid Crystal Display), and executes turning on, turning off, and blinking of the LEDs in a predetermined mode, display of information on the display panel, and the like under the control of the first control section 11.

The first communication interface 14 is a communication interface that executes communication with the access point 3 according to the Wi-Fi (registered trademark) standard. The first communication interface 14 has an antenna that receives a Wi-Fi (registered trademark) signal, and an interface circuit that received by the antenna. The first communication interface 14 is an interface board having an antenna and an interface circuit, and is coupled to a main board on which the first processor 11A or the like of the first control section 11 is mounted. Alternatively, the antenna and the interface circuit forming the first communication interface 14 are mounted on the main board of the first control section 11.

The first printing mechanism 15 executes a printing function under the control of the first control section 11. The first printing mechanism 15 prints characters, images, and the like on a printing medium such as printing paper using ink under the control of the first control section 11.

The first printing mechanism 15 includes a print head 151, a conveyance motor 152, and a conveyance roller 153 as configurations relating to printing.

The print head 151 is of an inkjet type, and ejects ink supplied from an ink supply unit (not shown) toward the printing medium. The print head 151 includes, for example, a plurality of line heads. The conveyance motor 152 rotationally drives the conveyance roller 153. The conveyance roller 153 conveys the printing medium in a conveyance direction.

The first scanner mechanism 16 reads images of characters, figures, and the like formed on a printing medium such as printing paper, and generates image information. Then, the first scanner mechanism 16 outputs the generated image information to the first control section 11.

The first facsimile mechanism 17 reads images of characters, figures, and the like formed on a printing medium such as printing paper, and generates image information. The first facsimile mechanism 17 transmits the generated image information to another facsimile apparatus via a public telephone line or the like. The first facsimile mechanism 17 receives image information from another facsimile apparatus via a public telephone line or the like. Then, the first facsimile mechanism 17 prints the received image information on a printing medium such as printing paper using the first printing mechanism 15, for example.

Further, as shown in FIG. 2, the first control section 11 includes a connection information output unit 111, a state transition unit 112, a determination unit 113, a setting information output unit 114, a first print control unit 115, a first communication control unit 116, and a first setting information storage unit 117. These respective units are implemented, for example, by the first processor 11A executing the first control program PG1 with the cooperation between software and hardware.

In other words, the first processor 11A executes the first control program PG1, and thereby, functions as the connection information output unit 111, the state transition unit 112, the determination unit 113, the setting information output unit 114, the first print control unit 115, and the first communication control unit 116. The first processor 11A executes the first control program PG1, and thereby, the first memory 11B functions as the first setting information storage unit 117. The first communication control unit 116 controls the first communication interface 14.

The first setting information storage unit 117 stores setting information JS set in advance for the first multifunction peripheral 1. The setting information JS includes, for example, print setting information, scan setting information, copy setting information, facsimile setting information including a telephone directory, network setting information, network security setting information, and administrator information.

The setting information JS will be further described with reference to FIG. 3.

The connection information output unit 111 outputs the connection information JC. The connection information JC contains the first connection information JC1 and the second connection information JC2. The second multifunction peripheral 2 makes a communication connection to the access point 3 based on the first connection information JC1. The second multifunction peripheral 2 makes a communication connection to the first multifunction peripheral 1 via the access point 3 based on the second connection information JC2.

The connection information output unit 111 generates, for example, image information JQ of a QR (Quick Response) code (registered trademark) representing the connection information JC. Then, the connection information output unit 111 causes the first printing mechanism 15 to print out the image information JQ of the QR code (registered trademark) on the printing medium.

The QR code (registered trademark) corresponds to an example of “two-dimensional barcode”.

The first connection information JC1 includes, for example, an SSID (Service Set Identifier) of the access point 3 and a password of the access point 3.

The second connection information JC2 includes, for example, a MAC address (Media Access Control address) AM of the first multifunction peripheral 1 and a unique key KQ.

The unique key KQ is generated when the connection information output unit 111 generates the image information JQ of the QR code (registered trademark). The unique key KQ is updated at each time when the connection information output unit 111 generates the image information JQ of the QR code (registered trademark). In other words, the unique key KQ is updated at each time when the connection information output unit 111 prints the QR code (registered trademark).

The unique key KQ here corresponds to an example of “first unique key”. In the following description, the unique key KQ generated and stored by the first multifunction peripheral 1 may be referred to as a first unique key KQ1. The first unique key KQ1 is a unique key KQ that can be obtained not via the second multifunction peripheral 2.

The state transition unit 112 causes the first multifunction peripheral 1 to transition between a normal state STN and a specific state STD.

In the normal state STN, for example, a print job is received from a personal computer or the like (not shown), and the first printing mechanism 15 is caused to execute the print job.

In the specific state STD, for example, the connection information output unit 111 prints out the connection information JC as a QR code (registered trademark). Further, in the specific state STD, for example, the second multifunction peripheral 2 is permitted to make a communication connection to the first multifunction peripheral 1 via the access point 3 is permitted.

The state transition unit 112 causes the first multifunction peripheral 1 to transition from the normal state STN to the specific state STD, for example, based on a user's operation on the first operation mechanism 12. Further, the state transition unit 112 causes the first multifunction peripheral 1 to transition to the normal state STN, for example, after a predetermined period TP elapses from the time point of transition to the specific state STD. The predetermined period TP is, for example, three hours.

The determination unit 113 determines whether a predetermined condition CP is satisfied. The predetermined condition CP is that a first condition C1 and a second condition C2 are satisfied.

The first condition C1 is that the second connection information JC2 is appropriate information. The first condition C1 is, for example, that a second unique key KQ2 input from the second multifunction peripheral 2 to the access point 3 matches the first unique key KQ1 generated by the first multifunction peripheral 1 when the second multifunction peripheral 2 requests a communication connection to the first multifunction peripheral 1.

The second condition C2 is that the first multifunction peripheral 1 is in the specific state STD.

In the embodiment, a case where the predetermined condition CP is that the first condition C1 and the second condition C2 are satisfied I will be described, however, the embodiment is not limited thereto. The predetermined condition CP may be satisfaction of at least one of the first condition C1 and the second condition C2. The predetermined condition CP may be, for example, satisfaction of the first condition C1 or the second condition C2. In this case, processing of the determination unit 113 can be simplified.

When the determination unit 113 determines that the predetermined condition CP is satisfied, the determination unit 113 permits the communication connection to the first multifunction peripheral 1 requested from the second multifunction peripheral 2.

When the determination unit 113 determines that the predetermined condition CP is not satisfied, the determination unit 113 prohibits the communication connection to the first multifunction peripheral 1 requested from the second multifunction peripheral 2.

When the second multifunction peripheral 2 makes a communication connection to the first multifunction peripheral 1 via the access point 3, the setting information output unit 114 reads the setting information JS of the first multifunction peripheral 1 from the first setting information storage unit 117 and transmits the read setting information JS to the second multifunction peripheral 2.

The first print control unit 115 receives a print job from a personal computer or the like (not shown), and causes the first printing mechanism 15 to execute the received print job.

The first communication control unit 116 controls the first communication interface 14. The first communication control unit 116 receives a request for a communication connection to the first multifunction peripheral 1 from the second multifunction peripheral 2 via the access point 3. Here, the first communication control unit 116 receives the MAC address AM of the first multifunction peripheral 1 and the second unique key KQ2 from the second multifunction peripheral 2.

When the second multifunction peripheral 2 makes a communication connection to the first multifunction peripheral 1 via the access point 3, the first communication control unit 116 transmits the setting information JS of the first multifunction peripheral 1 to the second multifunction peripheral 2. Next, the setting information JS will be described with reference to FIG. 3. FIG. 3 is a table showing an example of the setting information JS. As shown in FIG. 3, a classification CF, an item JT, and a content CT are shown from left to right.

The classification CF classifies the setting information JS in association with the functions of the first multifunction peripheral 1. The classification CF is classification into, for example, a print function, a scan function, a copy function, a facsimile function, a network function, and the like.

The item JT includes, for example, print setting information, scan setting information, copy setting information, facsimile setting information including a telephone directory, network setting information, network security setting information, and administrator information.

For example, the print setting information is contained in the classification CF corresponding to the print function.

For example, the scan setting information and the copy setting information are contained in the classification CF corresponding to the scan function and the copy function.

For example, the facsimile setting information including the telephone directory is contained in the classification CF corresponding to the facsimile function.

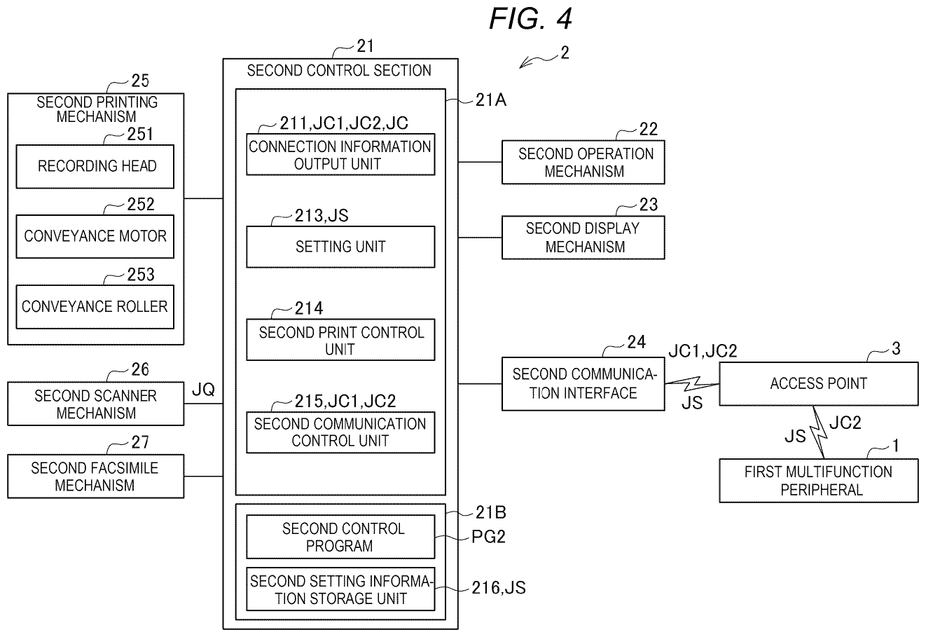

Next, a configuration of the second multifunction peripheral 2 will be described with reference to FIG. 4. FIG. 4 shows an example of the configuration of the second multifunction peripheral 2 according to the embodiment.

As shown in FIG. 4, the second multifunction peripheral 2 includes a second control section 21, a second operation mechanism 22, a second display mechanism 23, a second communication interface 24, a second printing mechanism 25, a second scanner mechanism 26, and a second facsimile mechanism 27.

The second control section 21 controls operation of the respective units of the second multifunction peripheral 2. Each of the second operation mechanism 22, the second display mechanism 23, the second communication interface 24, the second printing mechanism 25, the second scanner mechanism 26, and the second facsimile mechanism 27 is configured to communicate with the second control section 21.

The second control section 21 includes a second processor 21A such as a CPU, and a second memory 21B such as a ROM. The second memory 21B stores a second control program PG2.

The second processor 21A may include a plurality of processors or a single processor.

The second processor 21A may be hardware programmed to implement functions of the respective units, which will be described later. That is, the second processor 21A may have a configuration in which the second control program PG2 is mounted as a hardware circuit. In this case, for example, the second processor 21A includes an ASIC, an FPGA, or the like.

In the following description, the second processor 21A executes the second control program PG2 to implement various functions of the second control section 21.

The second memory 21B includes a nonvolatile storage area that stores programs and data in a nonvolatile manner. The second memory 21B may include, for example, a ROM, an HDD, or an SSD as the nonvolatile storage area. The second memory 21B may also include a volatile storage area and form a work area for temporarily storing programs to be executed by the second processor 21A and data to be processed. The second memory 21B may include, for example, a RAM as the volatile storage area.

The second operation mechanism 22 has the same configuration as the first operation mechanism 12 described above with reference to FIG. 2. The second display mechanism 23 has the same configuration as the first display mechanism 13 described above with reference to FIG. 2. The second communication interface 24 has the same configuration as the first communication interface 14 described above with reference to FIG. 2. The second printing mechanism 25 has the same configuration as the first printing mechanism 15 described above with reference to FIG. 2. The second scanner mechanism 26 has the same configuration as the first scanner mechanism 16 described above with reference to FIG. 2. The second facsimile mechanism 27 has the same configuration as the first facsimile mechanism 17 described above with reference to FIG. 2.

Further, as shown in FIG. 2, the second control section 21 includes a connection information acquisition unit 211, a setting unit 213, a second print control unit 214, a second communication control unit 215, and a second setting information storage unit 216. These respective units are implemented, for example, by the second processor 21A executing the second control program PG2 with the cooperation between software and hardware. In other words, the second processor 21A executes the second control program PG2, and thereby, functions as the connection information acquisition unit 211, the setting unit 213, the second print control unit 214, and the second communication control unit 215. The second processor 21A executes the second control program PG2, and thereby, the second memory 21B functions as the second setting information storage unit 216. The second communication control unit 215 controls the second communication interface 24.

The second setting information storage unit 216 stores the setting information JS. The setting unit 213 acquires the setting information JS from the first multifunction peripheral 1 when the second multifunction peripheral 2 makes a communication connection to the first multifunction peripheral 1 via the access point 3. Then, the setting unit 213 stores the setting information JS acquired from the first multifunction peripheral 1 in the second setting information storage section 216.

The connection information acquisition unit 211 receives the connection information JC.

The connection information acquisition unit 211 causes the second scanner mechanism 26 to generate image information JQ of a QR code (registered trademark) using a printing medium with the QR code (registered trademark) printed thereon by the first multifunction peripheral 1, for example. Then, the connection information acquisition unit 211 acquires the connection information JC from the image information JQ of the QR code (registered trademark). The connection information JC contains the first connection information JC1 and the second connection information JC2.

The first connection information JC1 includes, for example, the SSID of the access point 3 and the password of the access point 3.

The second connection information JC2 includes, for example, the MAC address AM of the first multifunction peripheral 1 and a unique key KQ.

The unique key KQ here corresponds to an example of “second unique key”. In the following description, the unique key KQ obtained via the second multifunction peripheral 2 may be referred to as a second unique key KQ2.

The second communication control unit 215 controls the second communication interface 24 to make a communication connection to the access point 3 based on the first connection information JC1. For example, the second communication control unit 215 transmits the first connection information JC1 to the access point 3 to request a communication connection to the access point 3. Then, the second communication control unit 215 makes a communication connection to the access point 3.

The second communication control unit 215 makes a communication connection to the first multifunction peripheral 1 via the access point 3 based on the second connection information JC2. For example, the second communication control unit 215 transmits the second connection information JC2 to the first multifunction peripheral 1 via the access point 3 to request a communication connection to the first multifunction peripheral 1. The second communication control unit 215 makes a communication connection to the first multifunction peripheral 1 via the access point 3.

When the second communication control unit 215 makes a communication connection to the first multifunction peripheral 1 via the access point 3, the setting unit 213 acquires the setting information JS from the first multifunction peripheral 1 via the second communication interface 24. Then, the setting unit 213 stores the acquired setting information JS in the second setting information storage unit 216.

The setting unit 213 executes processing of setting the acquired setting information JS in the first multifunction peripheral 1.

The second print control unit 214 receives a print job from a personal computer or the like (not shown), and causes the second printing mechanism 25 to execute the received print job.

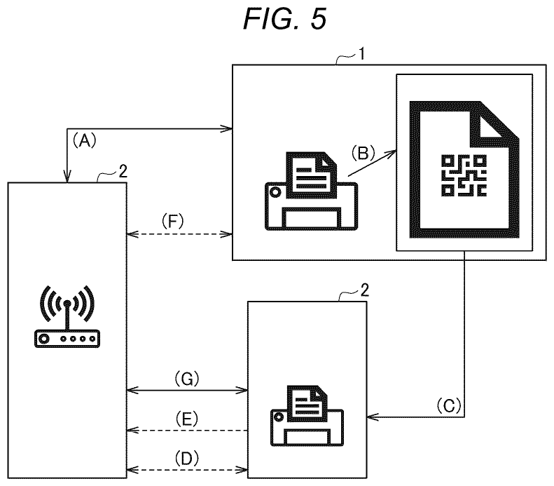

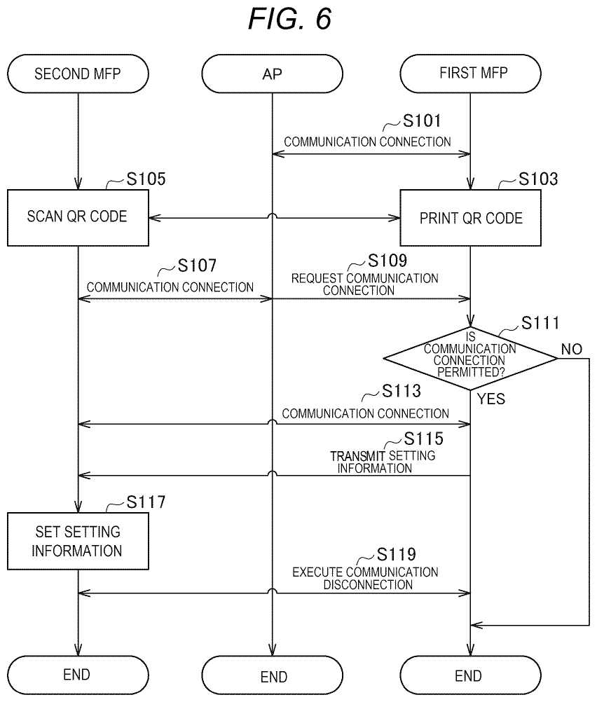

Next, an example of main processing of the communication system 100 will be described with reference to FIGS. 5 and 6. FIG. 5 shows an example of the main processing of the communication system 100. FIG. 6 is a sequence diagram showing the example of the main processing of the communication system 100.

In the following description, a case where the first multifunction peripheral 1 is in the specific state STD will be described.

First, in step S101, as shown by (A) in FIG. 5, the first control section 11 of the first multifunction peripheral 1 makes a communication connection to the access point 3.

Then, in Step S103, as shown by (B) in FIG. 5, the connection information output unit 111 of the first multifunction peripheral 1 prints out a QR code (registered trademark) representing the connection information JC. More specifically, the connection information output unit 111 updates the unique key KQ and prints out the QR code (registered trademark) representing the latest unique key KQ when the QR code (registered trademark) is printed out. The connection information output unit 111 stores the latest unique key KQ as the first unique key KQ1 in the first memory 11B.

Then, in Step S105, as shown by C in FIG. 5, the connection information acquisition unit 211 of the second multifunction peripheral 2 scans the printing medium with the QR code (registered trademark) printed thereon, and acquires the connection information JC. The connection information JC contains the first connection information JC1 and the second connection information JC2.

Then, in Step S107, as shown by (D) in FIG. 5, the second communication control unit 215 of the second multifunction peripheral 2 makes a communication connection to the access point 3 based on the first connection information JC1. More specifically, the second communication control unit 215 makes a communication connection to the access point 3 based on the SSID of the access point 3 and the password of the access point 3. Here, when a control unit (not shown) provided in the access point 3 determines that the password received from the second communication control unit 215 is valid, the control unit permits the communication connection between the second communication control unit 215 and the access point 3. On the other hand, when the control unit provided in the access point 3 determines that the password received from the second communication control unit 215 is invalid, the control unit prohibits the communication connection between the second communication control unit 215 and the access point 3. As below, a case where the communication connection between the second communication control unit 215 and the access point 3 is permitted will be described.

Then, in Step S109, as shown by (E) in FIG. 5, the second communication control unit 215 of the second multifunction peripheral 2 requests the first multifunction peripheral 1 via the access point 3 for a communication connection based on the second connection information JC2.

Next, in step S111, the determination unit 113 of the first multifunction peripheral 1 determines whether the predetermined condition CP is satisfied. The predetermined condition CP is that a first condition C1 and a second condition C2 are satisfied. The first condition C1 is that the second unique key KQ2 input from the second multifunction peripheral 2 to the access point 3 matches the latest first unique key KQ1 generated by the first multifunction peripheral 1 and stored in the first memory 11B. The second condition C2 is that the first multifunction peripheral 1 is in the specific state STD.

When the determination unit 113 determines that the predetermined condition CP is not satisfied (step S111; NO), the determination unit 113 prohibits the communication connection to the first multifunction peripheral 1 via the access point 3 by the second multifunction peripheral 2, and then, the processing ends. When the determination unit 113 determines that the predetermined condition CP is satisfied (step S111; YES), the determination unit 113 permits the communication connection to the first multifunction peripheral 1 via the access point 3 by the second multifunction peripheral 2, and the processing goes to step S113.

In step S113, as shown by (F) and (G) in FIG. 5, the second communication control unit 215 of the second multifunction peripheral 2 makes a communication connection to the first multifunction peripheral 1 via the access point 3.

Then, in step S115, the setting information output unit 114 of the first multifunction peripheral 1 transmits the setting information JS to the second multifunction peripheral 2.

Then, in step S117, the setting unit 213 of the second multifunction peripheral 2 executes processing of acquiring the setting information JS from the first multifunction peripheral 1 and setting the acquired setting information JS in the first multifunction peripheral 1.

Then, in step S119, the second communication control unit 215 of the second multifunction peripheral 2 breaks the communication connection to the first multifunction peripheral 1. Then, the processing ends.

As described above with reference to FIGS. 1 to 6, the communication system 100 according to the embodiment is the communication system 100 including the first multifunction peripheral 1, the second multifunction peripheral 2, and the access point 3 to which the first multifunction peripheral 1 makes a communication connection. The first multifunction peripheral 1 outputs the connection information JC including the first connection information JC1 for the second multifunction peripheral 2 to make a communication connection to the access point 3 and second connection information JC2 for the second multifunction peripheral 2 to make a communication connection to the first multifunction peripheral 1 via the access point 3, and the second multifunction peripheral 2 receives the input of the connection information JC and makes a communication connection to the access point 3 based on the first connection information JC1 contained in the connection information JC and makes a communication connection to the first multifunction peripheral 1 via the access point 3 based on the second connection information JC2 contained in the connection information JC.

According to the configuration, the second multifunction peripheral 2 can make a communication connection to the access point 3 and can further make a communication connection to the first multifunction peripheral 1 by the simple configuration. Accordingly, the user's convenience can be increased.

Further, in the communication system 100 according to the embodiment, when making a communication connection to the first multifunction peripheral 1 via the access point 3, the second multifunction peripheral 2 acquires the setting information JS of the first multifunction peripheral 1 and makes settings of the second multifunction peripheral 2 based on the setting information JS.

According to the configuration, settings of the second multifunction peripheral 2 can be easily made. Accordingly, time and effort for setting the second multifunction peripheral 2 can be reduced. Accordingly, the user's convenience can be increased.

In the communication system 100 according to the embodiment, the setting information JS includes the print setting information, the scan setting information, the copy setting information, the facsimile setting information including the telephone directory, the network setting information, the network security setting information, and the administrator information.

According to the configuration, since the setting information JS includes personal information such as the telephone directory and the administrator information, it is preferable to increase security by proper settings of the second connection information JC2.

Further, in the communication system 100 according to the embodiment, the first multifunction peripheral 1 has the determination unit 113. The determination unit 113 determines whether the predetermined condition CP is satisfied, when determining that the predetermined condition CP is satisfied, permits the communication connection to the first multifunction peripheral 1 requested from the second multifunction peripheral and, when determining that the predetermined condition CP is not satisfied, prohibits the communication connection to the first multifunction peripheral 1 requested from the second multifunction peripheral. The predetermined condition CP includes the first condition C1 indicating that the second connection information JC2 is appropriate information and the second condition C2 indicating that the first multifunction peripheral 1 is in a predetermined state.

According to the configuration, since the predetermined condition CP includes the first condition C1 indicating that the second connection information JC2 is appropriate information and the second condition C2 indicating that the first multifunction peripheral 1 is in the predetermined state, security can be increased.

In the communication system 100 according to the embodiment, the second connection information JC2 includes the first unique key KQ1 generated by the first multifunction peripheral 1, the second multifunction peripheral 2 requests a communication connection to the first multifunction peripheral 1 using the second unique key KQ2, and the first condition C1 is that the second unique key KQ2 matches the first unique key KQ1.

According to the configuration, since the first condition C1 is that the second unique key KQ2 matches the first unique key KQ1, security can be increased.

In the communication system 100 according to the embodiment, the first multifunction peripheral 1 prints the connection information JC as a QR code (registered trademark) on the printing medium, and updates the first unique key KQ1 at each time when printing the QR code (registered trademark).

According to the configuration, since the first unique key KQ1 is updated at each time when printing the QR code (registered trademark), security can be increased. For example, when the printing medium with the QR code (registered trademark) printed thereon is lost, the first unique key KQ1 can be updated by newly printing the QR code (registered trademark). Accordingly, security can be increased.

In the communication system 100 according to the embodiment, the first multifunction peripheral 1 transitions between the normal state STN and the specific state STD, and the second condition C2 is that the first multifunction peripheral 1 is in the specific state STD.

According to the configuration, since the second condition C2 is that the first multifunction peripheral 1 is in the specific state STD, security can be increased by proper settings of the specific state STD.

In the communication system 100 according to the embodiment, the first multifunction peripheral 1 prints the connection information JC as a QR code (registered trademark) on the printing medium in the specific state STD.

According to the configuration, since the connection information JC is printed on the printing medium as the QR code (registered trademark) in the specific state STD, the connection information JC is printed on the printing medium as the QR code (registered trademark) by the user setting the first multifunction peripheral 1 in the specific state STD. Accordingly, the user's convenience can be increased.

In the communication system 100 according to the embodiment, the first multifunction peripheral 1 transitions from the specific state STD to the normal state STN after the predetermined period TP elapses.

According to the configuration, since the multifunction peripheral transitions from the specific state STD to the normal state STN after the predetermined period TP elapses, security can be increased by setting of the predetermined period to an appropriate period. In order to increase security, it is preferable to set the predetermined period TP to a shorter period. On the other hand, when settings of a large number of multifunction peripherals are made using the setting information JS of the first multifunction peripheral 1, the operation time becomes longer, and it is preferable to set the predetermined period TP according to the operation time.

The first multifunction peripheral 1 according to the embodiment makes a communication connection to the access point 3, the first multifunction peripheral 1 outputs the connection information JC including the first connection information JC1 for the second multifunction peripheral 2 to make a communication connection to the access point 3 and the second connection information JC2 for the second multifunction peripheral 2 to make a communication connection to the first multifunction peripheral 1 via the access point 3, the first multifunction peripheral 1 transmits the setting information JS of the first multifunction peripheral 1 to the second multifunction peripheral 2 when the second multifunction peripheral 2 makes a communication connection to the first multifunction peripheral 1 via the access point 3 based on the connection information JC, and the setting information JS includes the print setting information, the scan setting information, the copy setting information, the facsimile setting information including the telephone directory, the network setting information, the network security setting information, and the administrator information.

According to the configuration, the second multifunction peripheral 2 can make a communication connection to the access point 3 and can further make a communication connection to the first multifunction peripheral 1 by the simple configuration. Accordingly, the user's convenience can be increased. Further, the settings of the second multifunction peripheral 2 can be easily made using the setting information JS of the first multifunction peripheral 1. Accordingly, time and effort for setting the second multifunction peripheral 2 can be reduced. Accordingly, the user's convenience can be increased. Since the setting information JS includes personal information such as the telephone directory and the administrator information, it is preferable to increase security by appropriate settings of the second connection information JC2.

The embodiment shows one aspect and any modifications and applications can be made thereto without departing from the spirit and scope of the present disclosure.

In the embodiment, the case where “first information processing apparatus” is the first multifunction peripheral 1 and “second information processing apparatus” is the second multifunction peripheral 2 is described, however, the embodiment is not limited thereto. It is only necessary that each of “first information processing apparatus” and “second information processing apparatus” may have a communication function and an information processing function. For example, each of “first information processing apparatus” and “second information processing apparatus” may be a personal computer. For example, each of “first information processing apparatus” and “second information processing apparatus” may be a projector.

In the embodiment, the case where “printing apparatus” is the multifunction peripheral is described, however, the embodiment is not limited thereto. It is only necessary that “printing apparatus” may include a printing function, a scanner function, a communication function, and an information processing function. “Printing apparatus” may be, for example, a copier.

In the embodiment, the first multifunction peripheral 1 and the access point 3 communicate with each other according to the Wi-Fi (registered trademark) standard, and the second multifunction peripheral 2 and the access point 3 communicate with each other according to the Wi-Fi (registered trademark) standard, however, the embodiment is not limited thereto. The first multifunction peripheral 1 and the access point 3 may communicate with each other according to the Ethernet (registered trademark) standard, and the second multifunction peripheral 2 and the access point 3 may communicate with each other according to the Ethernet (registered trademark) standard.

In the embodiment, the case where the first multifunction peripheral 1 prints out the connection information JC as the QR code (registered trademark) is described, however, the embodiment is not limited thereto. For example, the first multifunction peripheral 1 may print out the connection information JC as a two-dimensional barcode in another form. For example, the multifunction peripheral 1 may output the connection information JC to a memory such as a USB (Universal Serial Bus) (registered trademark) memory.

In the embodiment, the case where the first multifunction peripheral 1 includes the determination unit 113 is described, however, the embodiment is not limited thereto. For example, the access point 3 may include the determination unit 113.

In the embodiment, the case where the setting information JS includes the print setting information, the scan setting information, the copy setting information, the facsimile setting information including the telephone directory, the network setting information, the network security setting information, and the administrator information is described, however, the embodiment is not limited thereto. It is only necessary that the setting information JS includes at least one of the print setting information, the scan setting information, the copy setting information, the facsimile setting information including the telephone directory, the network setting information, the network security setting information, and the administrator information.

In the embodiment, the case where the first processor 11A of the first multifunction peripheral 1 executes the first control program PG1 stored in the first memory 11B and the second processor 21A of the second multifunction peripheral 2 executes the second control program PG2 stored in the second memory 21B is described, however, the embodiment is not limited thereto.

The first control program PG1 and the second control program PG2 may be configured as a recording medium that is recorded in a computer-readable manner, or a transmission medium that transmits the first control program PG1 and the second control program PG2.

As the recording medium, a magnetic or optical recording medium or a semiconductor memory device can be used. The recording medium includes a portable or fixed recording medium such as a flexible disc, an HDD, a CD-ROM (Compact Disk Read Only Memory), a DVD (Digital Versatile Disk), a Blu-ray (registered trademark) disc, a magneto-optical disc, a flash memory, and a card-type recording medium.

The printing medium may be a nonvolatile storage device such as a RAM, a ROM, or an HDD, which is an internal storage device provided in the first multifunction peripheral 1 and the second multifunction peripheral 2.

Each of the function of the first control section 11 of the first multifunction peripheral 1 and the function of the second control section 21 of the second multifunction peripheral 2 may be realized by one or more processors or a semiconductor chip. Each of the first control section 11 and the second control section 21 may further include a co-processor such as an SoC (System-on-a-Chip), an MCU (Micro Control Unit), or an FPGA. Each of the first control section 11 and the second control section 21 may operate both the CPU and the co-processor to cooperate with each other, or may selectively use one of both to perform various kinds of control.

The units of processing in the sequence diagram of FIG. 6 are formed by division according to the details of the main processing in order to facilitate understanding of the processing for ease of understanding of the processing of the communication system 100, but not limited by the way and the name of division of the units of processing. The units of processing in the sequence diagram may be divided into more units of processing according to the details of the processing. The units of processing may be formed by division such that one unit of processing includes more processing. The order of the processing may be suitably replaced without departing from the spirit and scope of the present disclosure.

Each functional unit shown in FIGS. 2 and 4 shows a functional configuration, and a specific implementation form is not particularly limited. Hardware individually corresponding to each of the functional units is not necessarily be implemented, but the functions of the plurality of functional units can be realized by a single processor executing the programs. Part of the functions realized by software in the above described embodiment may be realized by hardware, or part of the functions realized by hardware may be realized by software. In addition, the specific detailed configurations of the other respective units of the first multifunction peripheral 1 and the second multifunction peripheral 2 can be optionally changed without departing from the gist.

What is claimed is:

1. A communication system comprising:
a first information processing apparatus;
a second information processing apparatus; and
an access point to which the first information processing apparatus makes a communication connection, wherein
the first information processing apparatus outputs connection information including first connection information for the second information processing apparatus to make a communication connection to the access point and second connection information for the second information processing apparatus to make a communication connection to the first information processing apparatus via the access point, and
the second information processing apparatus receives input of the connection information, makes a communication connection to the access point based on the first connection information contained in the connection information, and makes a communication connection to the first information processing apparatus via the access point based on the second connection information contained in the connection information.

2. The communication system according to claim 1, wherein
when making a communication connection to the first information processing apparatus via the access point, the second information processing apparatus acquires setting information of the first information processing apparatus and makes settings of the second information processing apparatus based on the setting information.

3. The communication system according to claim 2, wherein
each of the first information processing apparatus and the second information processing apparatus is a printing apparatus, and
the setting information includes at least one of print setting information, scan setting information, copy setting information, facsimile setting information including a telephone directory, network setting information, network security setting information, and administrator information.

4. The communication system according to claim 1, wherein
at least one of the first information processing apparatus and the access point includes a determination unit,
the determination unit determines whether a predetermined condition is satisfied, when determining that the predetermined condition is satisfied, permits a communication connection to the first information processing apparatus requested from the second information processing apparatus and, when determining that the predetermined condition is not satisfied, prohibits the communication connection to the first information processing apparatus requested from the second information processing apparatus, and
the predetermined condition is at least one of a first condition indicating that the second connection information is appropriate information and a second condition indicating that the first information processing apparatus is in a predetermined state.

5. The communication system according to claim 4, wherein
the second connection information includes a first unique key generated by the first information processing apparatus,
the second information processing apparatus requests a communication connection to the first information processing apparatus using a second unique key, and
the first condition is that the second unique key matches the first unique key.

6. The communication system according to claim 5, wherein
the first information processing apparatus is a printing apparatus, and
the first information processing apparatus prints the connection information as a two-dimensional barcode on a printing medium, and updates the first unique key at each time when printing the two-dimensional barcode.

7. The communication system according to claim 4, wherein
the first information processing apparatus transitions between a normal state and a specific state, and
the second condition is that the first information processing apparatus is in the specific state.

8. The communication system according to claim 7, wherein
the first information processing apparatus is a printing apparatus, and
the first information processing apparatus prints the connection information as a two-dimensional barcode on a printing medium in the specific state.

9. The communication system according to claim 7, wherein
the first information processing apparatus transitions from the specific state to the normal state after a predetermined period elapses.

10. A printing apparatus making a communication connection to an access point,
the printing apparatus outputting connection information including first connection information for another printing apparatus to make a communication connection to the access point and second connection information for the other printing apparatus to make a communication connection to the printing apparatus via the access point,
the printing apparatus transmitting setting information of the printing apparatus to the other printing apparatus when the other printing apparatus makes a communication connection to the printing apparatus via the access point based on the connection information, wherein
the setting information includes at least one of print setting information, scan setting information, copy setting information, facsimile setting information including a telephone directory, network setting information, network security setting information, and administrator information.
